(19) United States
(12) Patent Application Publication
(10) Pub. No.: US 2010/0052846 A1
(43) Pub. Date: Mar. 4, 2010

(54) Control system for garage door

(75) Inventors: Jianhua Wang, Hangzhou (CN); Zijian Luo, Hangzhou (CN)

Correspondence Address: ZHEN ZHENG LU, 1730 HUNTINGTON DRIVE #304, DUARTE, CA, 91010, US

(73) Assignee: Powell Industry Co., Ltd.

(21) Appl. No.: 12/550,345

(22) Filed: Aug. 28, 2009

(30) Foreign Application Priority Data
Sep. 1, 2008 (CN) 200820163397.6

(51) Int. Cl. G08B 29/00

(52) U.S. Cl. 340/5.51; 340/5.71

(57) ABSTRACT

A control system for garage door includes a motor, a controller controlling operation of the motor, and a keyboard for inputting an instruction into the controller. The keyboard includes a plurality of keys, a plurality of resistors, a divider resistor for sharing voltage, and a voltage signal output circuit. The resistors correspond to the keys. Each key is connected with one of the resistors in series to form a key mapping signal shunt. The key mapping signal shunts are connected in parallel to form a group of key mapping signal shunts. The divider resistor is connected with the group of key mapping signal shunts in series to form a series circuit. A driving voltage is applied on the series circuit. The voltage signal output circuit is for transmitting a voltage on the group of key mapping signal shunts to the controller.

### BACKGROUND OF THE PRESENT INVENTION

1. Field of Invention

The present invention relates to a control system for garage door, and more particularly to a control system comprising a wall keyboard which outputs different potentials to represent outputting different instructions by operating different keys.

2. Description of Related Arts

In a garage door operator system, the user inputs instructions via an operation keyboard provided on a wall, wherein the electric circuit of the keyboard transfers states of the keys into electric signals of different values and then sends to a controller via one or more wires, and at last the controller controls a motor or other actuators to open or close the garage door, and turn on or turn off the working light.

The door operator ordinarily adopts the reactance method to transfer states of the keys into electric signals of different values, wherein the wall keyboard of the garage door operator is connected with the controller via one or more wires and sends key signals to the controller. The reactance-typed keyboard has each key connected with a reactor of different value, whose reactance is realized by capacitor. When a key is pressed, a driving circuit begins to charge the capacitor connected with the key, wherein the controller measures voltage change of the capacitor to make sure that whether a key is pressed. Afterward, because capacitors of different values have different discharge time, the controller measures the charge time and the discharge time of the capacitor to determine that which key is pressed. However, values of the capacitors of the above structure are easy to be changed under the influence of time and environmental factors such as temperature and humidity. The change of capacitor value causes the change of charge time and discharge time, and therefore causes the controller to misjudge the keys and the garage door to misact. In addition, capacitors have limited service life, and the price thereof is higher than resistors.

### SUMMARY OF THE PRESENT INVENTION

To overcome the above drawbacks existing in the prior art, the present invention provides a control system and method for a garage door, which improves the control signal transmission from keyboard to the controller thereof to fulfill the objects of increasing the operation liability and extending the service life of the keyboard.

Accordingly, the control system of the present invention comprises:

a motor;

a controller controlling operation of the motor; and

a keyboard for inputting an instruction into the controller, comprising a plurality of keys, a plurality of resistors corresponding to the keys, wherein each key is connected with one of the resistors in series to form a key mapping signal shunt, and the key mapping signal shunts are connected in parallel to form a group of key mapping signal shunts, a divider resistor for sharing voltage connected with the group of key mapping signal shunts in series to form a series circuit, wherein a driving voltage is applied on the series circuit, and a voltage signal output circuit for transmitting a voltage on the group of key mapping signal shunts to the controller.

Therefore, when the keyboard is idle, each key is disconnected to cut every key mapping signal shunt, thereby the voltage output by the voltage signal output circuit is equal to the provided driving voltage; when a key is pressed, the key mapping signal shunt where the key locates is connected and forms a series circuit with the divider resistor. Because the resistors respectively connected with the keys in series are different, the voltage on the key mapping signal shunt is different when different key is pressed. The voltage on the key mapping signal shunt is transmitted to the controller via the voltage signal output circuit for the controller to determine the corresponding key by the voltage on the key mapping signal shunt, so as to take correct action to operate the garage door and a working light. The present invention adopts resistors of different values to distinguish different keys. As comparing to capacitors, resistors have more stable parameters, are less affected by factors such as environmental temperature and humidity, and therefore reduce misjudgment of keys; besides, resistors have longer service life, low cost and low failure rate; and the keyboard has simple circuit structure, and needs only two wires connected with the driving circuit of the keyboard of the controller, and therefore is convenient to connect, simple and reliable.

To further perfect and supplement the above embodiment, the present invention have the following features or combination of the features.

The group of key mapping signal shunts has a first end connected with the divider resistor in series, and a second end grounded. The divider resistor has a first end connected with the group of key mapping signal shunts, and a second end connected and applied with a signal of the driving voltage. The voltage signal output circuit extends to the controller from a connection point between the group of key mapping signal shunts and the divider resistor.

The keyboard further comprises a key locking circuit. The key locking circuit is connected to a locking signal output terminal of the controller. When the controller sends a locking signal, the key locking circuit keeps the voltage output by the group of key mapping signal shunts unchanged, and therefore any key is disenable. When the controller sending a unlocking signal, the voltage output by the group of key mapping signal shunts is changed by the keys.

The key locking circuit comprises a NPN transistor which has a collector and a grounded emitter connected with the group of key mapping signal shunts in parallel. The locking signal output terminal of the controller is grounded via a tandem connected current limit resistor and pull-down resistor. The NPN transistor has a base connected with a node between the current limit resistor and the pull-down resistor. In an unlocking manner, the locking signal output terminal outputs a low electric level signal, such that the base of the transistor has no current, and the transistor is off, when the voltage output by the group of key mapping signal shunts is responded to the keys. In a locking manner, the locking signal output terminal outputs a high electric level signal, such that the current limit resistor and the pull-down resistor have current passing through to provide current to the base, and the transistor is on, in such a manner that the group of key mapping signal shunts is in short circuit, and when any key is pressed, the voltage output by the group of key mapping signal shunts approximates zero, and the controller judges to take no action.

The key locking circuit further comprises a diode provided between the locking signal output terminal and the current limit resistor to prevent adverse current to the controller.

The keyboard further comprises an indicating circuit connected with the group of key mapping signal shunts in parallel and comprising a LED and a LED current limit resistor which are connected in series. When the key is pressed effectively, the LED indicates a corresponding state.

The keyboard comprises five key mapping signal shunts respectively corresponding to keys of switching, travel learning, remote control learning, remote control locking, and light controlling, so as to instruct the controller to take actions of opening or closing the garage door, setting an upper limit position and a lower limit position of the garage door, learning a remote controller, locking the remote controller, and controlling an indicating and illuminating lamp.

The control system for the garage door further comprises an infrared alarm means for monitoring if there is an obstruction under the garage door.

The control system for the garage door further comprises a remote controller for controlling the garage door remotely when it is not convenient to operate the keyboard.

The control system for the garage door further comprises a motion detecting device for detecting a position, a speed and other information of the garage door.

The wall keyboard with the improvement by present invention has the advantages of stable operation, less misaction, lower cost, extended service life, convenient use and safety.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a control system for a garage door according to a preferred embodiment of the present invention.

FIG. 2 is a schematic diagram of the control system according to the preferred embodiment of the present invention.

FIG. 3 is a circuit logic diagram of a keyboard of the control system according to the preferred embodiment of the present invention.

### DETAILED DESCRIPTION OF THE PREFERRED EMBODIMENT

Referring to FIG. 1 of the drawings, a control system for a garage door according to a preferred embodiment of the present invention is illustrated, wherein a keyboard 101 provided on a wall is connected to a head 103 comprising a motor, a controller, a motion detecting device and so on therein via a wire 102. A user controls the motor in the head 103 to rotate positively or reversely via the keyboard 101, wherein the motor in the head 103 pushes or pulls a garage door 106 via a transmission chain 104 and a connected rod 105, so as to open or close the garage door 106.

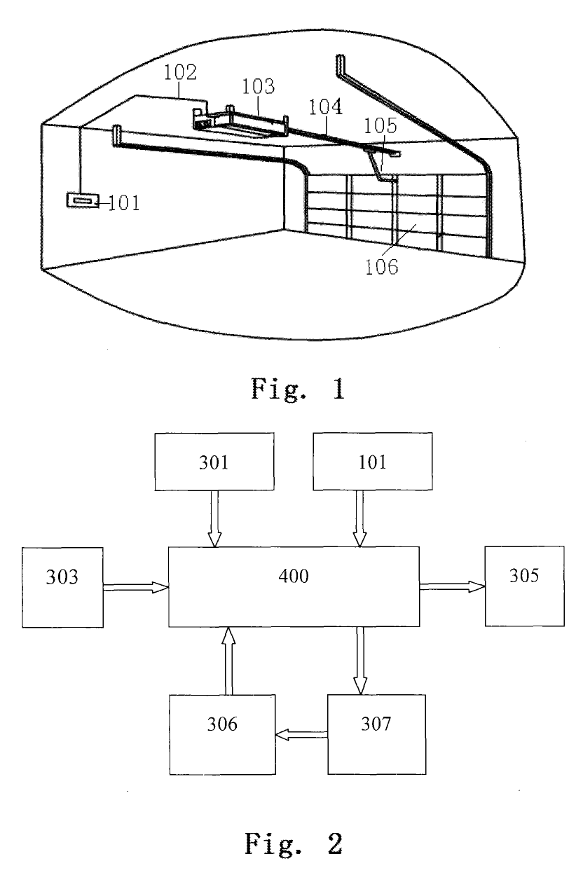

Referring to FIG. 2 of the drawings, the control system may further comprise an infrared alarm means 301, a remote controller 303, an indicating lamp 305 and the motion detecting device 306, all of which are connected with a single chip 400 which acts as a core of the controller. A power and transmission device 307 illustrated in the drawings comprises the motor and a transmission mechanism.

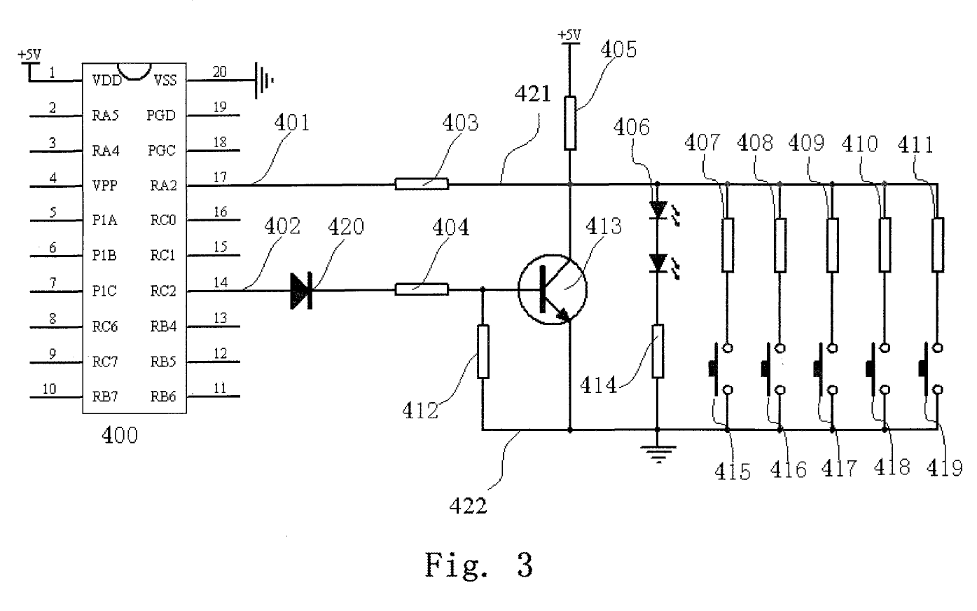

An electric circuit of the keyboard 101 is illustrated in FIG. 3 of the drawings, wherein five keys 415, 416, 417, 418, 419 are connected respectively with five key mapping signal resistors 407, 408, 409, 410, 411 of different values in series to form five key mapping signal shuntswhich are then connected in parallel to form a group of key mapping signal shunts which is also connected with an indicating circuit comprising a LED 406 and a LED current limit resistor 414 in parallel. The group of key mapping signal shunts has a first end grounded, and a second end connected with a divider resistor 405 having another end connected and applied with a driving voltage in series. The driving voltage is 5V as illustrated in the drawings, and can be adjusted according to particular condition. A circuit node between the group of key mapping signal shunts and divider resistor outputs a voltage, and is connected to an A/D conversion pin 401 of the single chip 400, which acts as the core of the controller, via a voltage signal output circuit. The voltage signal output circuit comprises a current limit resistor 403.

A key locking circuit comprises a NPN transistor 413, a diode 420, a current limit resistor 404 and a pull-down resistor 412. The single chip 400 has a RC2 pin 402 as a locking signal output terminal, which is connected with the diode 420, the current limit resistor 404, the pull-down resistor 412, and then the ground. A node between the current limit resistor 404 and the pull-down resistor 412 is connected to a base of the NPN transistor 413. The current limit resistor 404, the pull-down resistor 412, and the diode 420 are connected with the base, and an emitter and a collector of the NPN transistor 413 are connected in parallel beside the group of key mapping signal shunts.

In working, the single chip 400 scans the keys of the keyboard periodically. When scanning the keyboard, the RC2 pin 402 is first set to low, and at that time the NPN transistor 413 is off. The pressed key is connected with the corresponding resistor and the divider resistor 405 in series to share the driving voltage. When different key is pressed, the key mapping signal resistor connected in series is different, and therefore a resistance produced between two signal wires 421 and 422 of the keyboard is different. When a voltage of 5V is applied on the two signal wires 421 and 422 via the divider resistor 405, an electric level value produced on the signal wire 421 is different. By utilizing an A/D module function of the single chip 400, different electric level values are converted into different digital signals. The single chip 400 detects the pressed key of the keyboard on the wall by reading the digital signals.

If the RC2 pin 402 is set high, the NPN transistor 413 is on, an electric level value of the signal wire 421 of the keyboard on the wall approximates zero, when the keyboard is locked, any key input is useless.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A control system for a garage door, comprising:
a motor;
a controller controlling operation of said motor; and
a keyboard for inputting an instruction into said controller, comprising a plurality of keys, a plurality of resistors corresponding to said keys, wherein each key is connected with one of the resistors in series to form a key mapping signal shunt, and said key mapping signal shunts are connected in parallel to form a group of key mapping signal shunts, a divider resistor connected with said group of key mapping signal shunts in series to form a series circuit, wherein a driving voltage is applied on said series circuit, and a voltage signal output circuit for transmitting a voltage on said group of key mapping signal shunts to said controller.

2. The control system, as recited in claim 1, wherein said group of key mapping signal shunts has a first end connected with said divider resistor in series and a second end grounded, said divider resistor has a first end connected with said group of key mapping signal shunts and a second end connected and applied with a signal of the driving voltage, said voltage signal output circuit extends to said controller from a connection point between said group of key mapping signal shunts and said divider resistor.

3. The control system, as recited in claim 1, wherein said keyboard further comprises a key locking circuit, wherein said controller has a locking signal output terminal connected with said key locking circuit.

4. The control system, as recited in claim 2, wherein said keyboard further comprises a key locking circuit, wherein said controller has a locking signal output terminal connected with said key locking circuit.

5. The control system, as recited in claim 3, wherein said key locking circuit comprises:
a NPN transistor which has a collector, a grounded emitter and a base, wherein said collector and said emitter are connected with said group of key mapping signal shunts in parallel;
a current limit resistor; and
a pull-down resistor connected with said current limit resistor in series, wherein said locking signal output terminal of said controller is grounded via said current limit resistor and said pull-down resistor in sequence, and said base is connected with a node between said current limit resistor and said pull-down resistor.

6. The control system, as recited in claim 4, wherein said key locking circuit comprises:
a NPN transistor which has a collector, a grounded emitter and a base, wherein said collector and said emitter are connected with said group of key mapping signal shunts in parallel;
a current limit resistor; and
a pull-down resistor connected with said current limit resistor in series, wherein said locking signal output terminal of said controller is grounded via said current limit resistor and said pull-down resistor in sequence, and said base is connected with a node between said current limit resistor and said pull-down resistor.

7. The control system, as recited in claim 3, wherein said key locking circuit further comprises a diode provided between said locking signal output terminal and said current limit resistor.

8. The control system, as recited in claim 4, wherein said key locking circuit further comprises a diode provided between said locking signal output terminal and said current limit resistor.

9. The control system, as recited in claim 6, wherein said key locking circuit further comprises a diode provided between said locking signal output terminal and said current limit resistor.

10. The control system, as recited in claim 5, wherein said keyboard further comprises an indicating circuit connected with said group of key mapping signal shunts in parallel, wherein said indicating circuit comprises a LED and a LED current limit resistor which are connected in series.

11. The control system, as recited in claim 6, wherein said keyboard further comprises an indicating circuit connected with said group of key mapping signal shunts in parallel, wherein said indicating circuit comprises a LED and a LED current limit resistor which are connected in series.

12. The control system, as recited in claim 9, wherein said keyboard further comprises an indicating circuit connected with said group of key mapping signal shunts in parallel, wherein said indicating circuit comprises a LED and a LED current limit resistor which are connected in series.

13. The control system, as recited in claim 12, wherein said keyboard comprises five key mapping signal shunts respectively corresponding to keys of switching, travel learning, remote control learning, remote control locking, and light controlling.

14. The control system, as recited in claim 12, further comprising an infrared alarm means.

15. The control system, as recited in claim 12, further comprising a remote controller.

16. The control system, as recited in claim 12, further comprising a motion detecting device.

17. A method of transmitting a control signal from a keyboard to a controller to control a garage door, comprising:
connecting each key of the keybard with a resistor to form a key mapping signal shunt;
connecting the key mapping signal shunts in parallel to form a group of key mapping signal shunts;
connecting a divider resistor with the group of key mapping signal shunts in series to form a series circuit;
applying a driving voltage on the series circuit; and then transmitting a voltage on the group of key mapping signal shunts as the control signal via a voltage signal output circuit to the controller.

18. The method, as recited in claim 17, further comprising:
before transmitting the voltage, connecting a first end of the group of key mapping signal shunts with the divider resistor in series;
grounding a second end of the group of key mapping signal shunts;
connecting a first end of the divider resistor with the group of key mapping signal shunts;
connecting and applying a signal of the driving voltage to a second end of the divider resistor; and
extending the voltage signal output circuit to the controller from a connection point between the group of key mapping signal shunts and the divider resistor.

19. The method, as recited in claim 18, further comprising connecting a locking signal output terminal with a key locking circuit before transmitting the voltage.

20. The method, as recited in claim 19, wherein the key locking circuit comprises:
a NPN transistor which has a collector, a grounded emitter and a base, wherein the collector and the emitter are connected with the group of key mapping signal shunts in parallel;
a current limit resistor; and
a pull-down resistor connected with the current limit resistor in series, wherein the locking signal output terminal of the controller grounded via the current limit resistor and the pull-down resistor in sequence, and the base is connected with a node between the current limit resistor and the pull-down resistor.
